(19) United States
(12) Patent Application Publication
(10) Pub. No.: US 2010/0224068 A1
(43) Pub. Date: Sep. 9, 2010

(54) GAS ADSORPTION MEDIUM AND GAS ADSOPRTION PUMP APPARATUS USING THE SAME

(75) Inventors: Han Young Yu, Daejeon (KR); Byung Hoon Kim, Incheon (KR); Yark Yeon Kim, Daejeon (KR)

Correspondence Address: AMPACC Law Group, 3500 188th Street S.W., Suite 103, Lynnwood, WA, 98037, US

(73) Assignee: ELECTRONICS AND TELECOMMUNICATIONS RESEARCH INSTITUTE, DAEJEON (KR)

(21) Appl. No.: 12/677,909

(22) PCT Filed: May 30, 2008
(86) PCT No.: PCT/KR08/03053

§ 371 Date: Mar. 12, 2010

(30) Foreign Application Priority Data
Sep. 7, 2007 (DE) 102007042721.4

(51) Int. Cl. B01D 53/02

(52) U.S. Cl. 96/131

(57) ABSTRACT

A gas adsorption medium and an adsorption pump apparatus having the same are provided. The gas adsorption medium includes a multi-layered structure of which the layers formed of a material are spaced apart from each other, wherein an ion valence of the material is variable and the material includes extra electrons not participating in a chemical bond, and the adsorption pump apparatus includes the gas adsorption medium as described above. The gas adsorption medium can secure a large surface area by securing a space between the layers so that efficiency of the gas adsorption ability can be enhanced.

### TECHNICAL FIELD

The present invention relates to a gas adsorption medium and an adsorption pump apparatus including the same. More particularly, the present invention relates to a gas adsorption medium which sufficiently secures a surface area for gas adsorption to improve the efficiency of adsorbing the gas and an adsorption pump apparatus including the same.

### BACKGROUND ART

In general, an “adsorption pump” refers to a vacuum pump for ultra high vacuum which collects gases in a chamber by cooling and condensing the gases at an extremely low temperature to maintain the degree of vacuum at a low state.

In the prior art, charcoals and activated charcoals having high adsorption ability have been stacked on such an adsorption pump to collect gases distributed in a vacuum chamber.

In addition, when superior media such as the charcoal and activated charcoal were employed for the adsorption pump having high efficiency, the performance of the pump was able to be enhanced.

Accordingly, when media having a higher ability to collect gases and a lower degree of desorption than the charcoal and activated charcoal are employed, high vacuum may be more easily accomplished, and thus much research on such media has been conducted in the field as described above.

To this end, the present inventors have researched the adsorption media, and found that the adsorption efficiency may be enhanced when the adsorption medium is formed to have a multi-layered structure in which the layers are spaced apart from each other using the material with extra electrons not participating in a chemical bond, thereby completing the present invention.

### DISCLOSURE OF INVENTION

### Technical Problem

The present invention is directed to a gas adsorption medium which sufficiently secures a surface area for gas adsorption to improve the efficiency of adsorbing the gas, and an adsorption pump apparatus including the same.

### Technical Solution

One aspect of the present invention provides a gas adsorption medium including a multi-layered structure of which the layers formed of an ion valence-variable material with extra electrons not participating in a chemical bond are spaced apart from each other.

Another aspect of the present invention provides a gas adsorption apparatus including a gas adsorption medium having a multi-layered structure of which the layers formed of an ion valence-variable material with extra electrons not participating in a chemical bond are spaced apart from each other.

### ADVANTAGEOUS EFFECTS

The present invention including the configuration as described above has the following advantages:

First, spaces between layers of a gas adsorption medium having a multi-layered structure according to the present invention are secured, which in turn results in a large surface area, so that the efficiency of adsorbing the gas can be enhanced.

Second, in the gas adsorption medium having the multi-layered structure, materials capable of being easily adsorbed or desorbed are filled between the layers in advance and then are desorbed through vacuum and heating for adsorbing gases, so that spaces where the gases are to be adsorbed are easily formed, thereby not only enhancing the ability of adsorbing the gases but recycling the gas adsorption medium.

### BRIEF DESCRIPTION OF THE DRAWINGS

FIG. 1 illustrates the structure of a gas adsorption medium according to an exemplary embodiment of the present invention;

FIGS. 2A and 2B illustrate crystalline vanadium pentoxide nanowire structures;

FIG. 3 illustrates analysis results of the crystalline vanadium pentoxide nanowire structure by means of Thermogravimetric Analysis (TGA) according to experiments of the present invention.

FIG. 4 illustrates the configuration of a mass spectrometry for measuring an amount of adsorbed hydrogen;

FIG. 5 illustrates hydrogen adsorption characteristics of a crystalline vanadium pentoxide nanowire structure according to experiments of the present invention;

FIG. 6 illustrates the configuration of an adsorption pump using a gas adsorption medium according to an exemplary embodiment of the present invention; and

FIG. 7 illustrates a scanning electron microscope (SEM) photo of a synthesized crystalline vanadium pentoxide nanowire structure according to an exemplary embodiment of the present invention.

### DESCRIPTION OF MAPR SYMBOL IN THE ABOVE FIGURES

110: gas adsorption medium

120: ion valence-variable material (nanowire crystalline material)

130: empty space

210: gas adsorption medium

220: crystalline vanadium pentoxide nanowire material

230: water

410: quartz crystal oscillator

420: electrode

430: nanowire

610: nanowire adsorption material

620: cooling panel

630: cooler

### MODE FOR THE INVENTION

Hereinafter, exemplary embodiments of the present invention will be described in detail. However, the present invention is not limited to the exemplary embodiments disclosed below, but can be implemented in various types. Therefore, the present exemplary embodiments are provided for complete disclosure of the present invention and to fully inform the scope of the present invention to those ordinarily skilled in the art. In addition, like numbers refer to like elements throughout the specification.

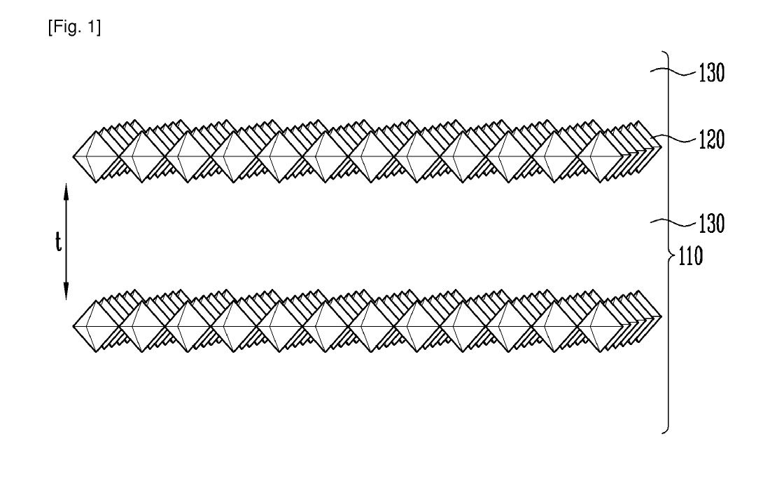

Referring to FIG. 1, a gas adsorption medium according to an embodiment of the present invention has a multi-layered structure of which the layers formed of a material 120 having a variable ion valence are spaced apart from each other.

In this case, the material 120 having the variable ion valence must have extra electrons not participating in a chemical bond, and, instead of having the same crystalline material continuously distributed, must also have an asymmetric structure in which at least two structures are bonded to each other so that the material can have extra electrons.

According to the present invention, the gas adsorption medium 110 refers to the material 120 having a multi-layered structure. For example, as shown in FIG. 1, when the material 120 having a thin film structure is present, the material 120 includes empty spaces 130 between the layers thereof.

The empty spaces 130 within the material 120 are also present in a material such as graphite having a layered structure which is well known in the art, but a carbonic bond is stably present in a case of graphite, so that graphite cannot act as an adsorption medium since even when a material to be adsorbed, such as hydrogen, is adsorbed into the empty space, the material is apt to be desorbed.

Accordingly, the adsorption principle of the present invention is to use extra electrons resulting from defects or other factors in a structure having a chemical bond to adsorb a material of interest, including hydrogen, by means of electrical and chemical attractions.

For example, in a case of a transition metal such as vanadium which is crystalline and has a layered structure, vanadium present in the layered structure has a tetravalent or pentavalent form depending on how the vanadium is bonded with oxygen at the time of chemical bond. When a bond between the vanadium and oxygen has defects at any one portion due to such variations in vanadium ion valence, extra electrons are floating, and these electrons exhibit a property of easily adsorbing molecules or atoms which are externally injected, that is, a material to be adsorbed. In addition, the structure of the vanadium oxide contains a pyramidal crystalline material. The crystalline material, however, is not continuously distributed but are arranged askew, giving the vanadium oxide an asymmetrical structure. This asymmetry takes effects on a possibility of having additional extra electrons.

However, when a distance between vanadium layers is as wide as a micrometer, a present chemical bond is not strong enough to affect the structure between the next layers, so that the unstable chemical bond having extra electrons cancels out neighboring other chemical bonds. Further, when the distance between layers is large, a desorbing force is greater than an adsorbing force for adsorbing the material so that the adsorbing force becomes weaker. That is, the adsorbing force increases due to an attraction occurring from both layers when the material is adsorbed between the layers, however, decreases due to an attraction of almost one layer other than both layers when the distance between the layers is larger.

For example, when an element such as vanadium is bonded with oxygen, the balance with respect to their bond has a +3 valence in the case of V₂O₃ and a +4 valence in the case of VO₂. In addition, vanadium has any rate of a +4 or +5 valence according to bonds in the case of V₂O₅. When the balance is obtained using any such rate, extra electrons remain according to the degree of change in ion valence, which thus act as an attraction of holding the material to be adsorbed.

Accordingly, when a material with a variable ion valence and extra electrons has a layered structure, a material to be adsorbed may be easily adsorbed by the material with extra electrons. In addition, the material adsorbed by the attraction between the materials having the layered structure does not have a strong chemical bond so that it may also be easily desorbed. That is, the bond between the material and the adsorption object may be a covalent bond, a van der Waals bond, an ionic bond, a hydrogen bond, or a metallic bond so that the material may be easily desorbed.

Meanwhile, it is very important to secure a space allowing a material including air to be adsorbed. Such a space may be sufficiently secured when the materials having a variable ion valence are spaced apart from each other to have a layered structure, and the material to be adsorbed has a chemical bond depending on an ion valence thereof in the space. In this case, the chemical bond includes a covalent bond, a van der Waals bond, an ionic bond, a hydrogen bond, or a metallic bond.

As such, all layers of the multi-layered structure may be formed of the same material, or different materials, for example, at least two different materials, which are used to form the gas adsorption medium 110 for adsorbing a material to be adsorbed.

The material 120 forming the layers of the gas adsorption medium 110 may employ a nanowire crystalline material, which may be formed as a nano thin film, a pellet, a bulk, or a film.

In addition, the nanowire crystalline material includes at least one cross-sectional dimension less than 500 nm, preferably less than 100 nm, and has an aspect ratio (length:width ratio) greater than 10, preferably greater than 50, and more preferably greater than 100. The magnitude of the cross-sectional area is greater than 10 square nanometers and smaller than 100 square centimeters.

In addition, the nanowire crystalline material may be formed of any one material selected from the group consisting of a semiconductor nano material, a compound bonded with transition metal and transition metal oxides.

In this case, the semiconductor nano material may include any one selected from the group consisting of Si, Ge, Sn, Se, Te, B, C(including diamond), P, B—C, B—P(BP6), B—Si, Si—C, Si—Ge, Si—Sn, Ge—Sn, SiC, BN/BP/BAs, AlN/AlP/AlAs/AlSb, GaN/GaP/GaAs/GaSb, InN/InP/InAs/InSb, BN/BP/BAs, AlN/AlP/AlAs/AlSb, GaN/GaP/GaAs/GaSb, InN/InP/InAs/InSb, ZnO/ZnS/ZnSe/ZnTe, CdS/CdSe/CdTe, HgS/HgSe/HgTe, BeS/BeSe/BeTe/MgS/MgSe, GeS, GeSe, GeTe, SnS, SnSe, SnTe, PbO, PbS, PbSe, PbTe, CuF, CuCl, CuBr, CuI, AgF, AgCl, AgBr, AgI, BeSiN₂, CaCN₂, ZnGeP₂, CdSnAs₂, ZnSnSb₂, CuGeP₃, CuSi₂P₃, (Cu, Ag)(Al, Ga, In, Ti, Fe)(S, Se, Te)₂, Si₃N₄, Ge₃N₄, Al₂O₃, (Al, Ga, In)₂(S, Se, Te)₃, Al₂CO, and a combination containing at least two thereof.

The transition metal may include Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, or Hg For example, when the material to be adsorbed is hydrogen, the transition metal may be formed of a compound bonded with an element such as Pt or Pd.

In addition, the compound bonded with the transition metal may include any one selected from compounds in which the transition metal is bonded with other material or another transition metal and thus is stabilized, such as a compound bonded with Ni (e.g, LaNi₅, MnNi₃, Mg₂Ni), a compound bonded with Ti (e.g, TiMn₂, TiV₂, TiFe, TiCo, TiVCr, TiVMn), a compound bonded with Cu (e.g, Mg₂Cu), a compound bonded with Zr (e.g, ZrMn₂, ZrV₂), and a compound bonded with Li (e.g, LiAl).

The transition metal oxide may have a composition ratio such as vanadium oxide, e.g, VO₂, V₂O₃, V₂O₅, and may include any composition ratio so long as an ion valence thereof becomes an extra ion valence.

The compound bonded with the element such as Pt or Pd may include any one selected from compounds bonded with materials of which elements such as Pt or Pd, which easily react with hydrogen, are bonded with the transition metal, oxygen or the like. For example, the material such as Pt or Pd adsorbs hydrogen so that it may be used as a hydrogen sensor, however, it is not used as an adsorbing material. However, when such compounds have a layered structure, adsorption may occur, and when the material such as a transition metal has extra electron pairs, this may increase an adsorption energy to reduce the desorption possibility when a material such as a gas including air is adsorbed to the material such as Pt or Pd. In addition, when the material such as Ti which allows oxidation to easily occur has the structure as described above, adsorption due to the oxidation and effects of the extra electrons may be simultaneously applied to the material so that the adsorption may be facilitated.

Meanwhile, impurity ion doping may be applied to the compound bonded with the transition metal and the transition metal oxides described above to form their structure and ion valence, and may be carried out during a sample synthesis, and impurity ion doping by an ion implantation process using transition metal ions after the sample synthesis may also be employed.

For example, in a case of vanadium pentoxide nanowire, a molecular material containing Pt or Pd may also be implanted to carry out doping between layers or on the layer of the layered structure to increase adsorption ability during the sample synthesis.

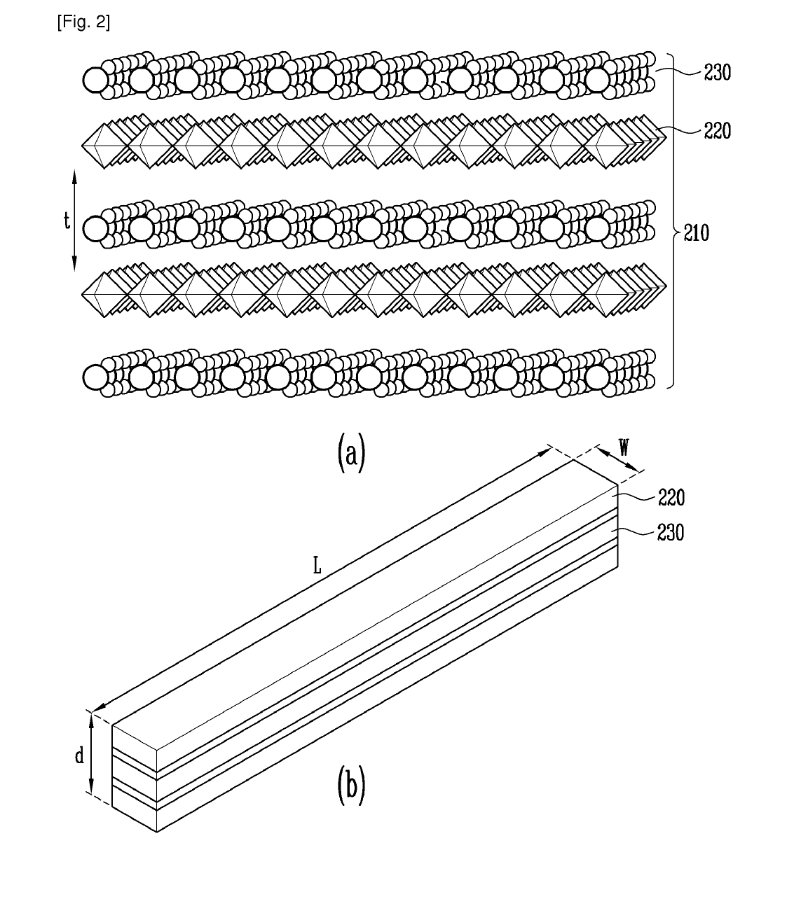

For example, as shown in FIGS. 2A and 2B, referring to the structure of the vanadium pentoxide nanowire, it can be seen that water 230 contained during the sample synthesis is present between crystalline vanadium pentoxide nanowire materials 220. In this case, a distance t between layers of the crystalline vanadium pentoxide nanowire material 220 is about 0.67 nm, and a thickness of the crystalline vanadium pentoxide nanowire material 220 is about 0.48 nm. The distance t between the layers of the crystalline vanadium pentoxide nanowire material 220 is adjusted when the water 230 is collected or desorbed. At this time, the distance t between the layers of the crystalline vanadium pentoxide nanowire material 220 must be short so as to have attractions from both the layers, and there is hardly attraction when the distance is more than several hundred nanometers. Accordingly, the distance t between the layers of the crystalline vanadium pentoxide nanowire material 220 must not be greater than 100 nm, and should preferably in a range of 0.1 nm to 100 nm.

FIG. 2B illustrates a crystal of the crystalline vanadium pentoxide nanowire material 220 having a bar shape. A bulk formed of several crystalline vanadium pentoxide nanowire materials having a bar shape is facilitated to adsorb a material of interest.

The nanowire crystalline material of the gas adsorption medium 110 includes all types of nanowire crystalline materials which have a width W, a height (or thickness) d, and a length L corresponding to several tens of nanometers, several nanometers, and several tens of micrometers, respectively.

A general thin film is deposited on a top portion of a three-dimensional structure, so that it is difficult to adsorb or insert a new material between the thin films. In contrast, the width of the nanowire crystalline material corresponding to several nanometers is much narrower than the general thin film, so that the nanowire crystalline material requires very low energy when a material of interest needs to be adsorbed between the nanowires.

In addition, the gas adsorption medium 110 of the present invention is not limited to the nanowire crystalline material having the width and height corresponding to several nanometers, but may include all structures of a thin film having a layered structure based on the nanowire crystalline material with such width and height. This thin film includes any kind of thin film that has a width of several tens of millimeters to several tens of centimeters and has uniformly distributed layers. At this time, when the width of the nanowire crystalline material is several nanometers to several tens of nanometers and a single crystal thereof has a height of several nanometers, a material containing hydrogen may be adsorbed.

In addition, one layer with a width ranging from several tens of nanometers to several tens or hundreds of centimeters may have a length ranging from several tens of nanometers to several hundred centimeters. In this case, thicknesses of the single crystal and thin film, i.e., a distance between the layers must not be greater than several nanometers. The distance between the layers must be not greater than several nanometers so as to have stable chemical and physical bonds of the material to be adsorbed including hydrogen. In a case of tube shape, i.e., a hollow cylinder, the entire attraction is applied thereto in a uniformly distributed manner, so that the diameter of the tube may be up to several hundred nanometers.

In addition, the gas adsorption medium 110 is not limited to a flat plate structure but may have almost any structure that including a structure bent from the flat plate structure, a hollow cylindrical structure, or a spherical structure. At this time, each of the structures preferably includes a crystalline material having a crystallized portion with a surface area of nanometer or greater.

As described above, the gas adsorption medium 110 includes a structure composed of a nanowire crystalline material having a multi-layered structure and a material capable of being adsorbed or desorbed between the layers, which are chemically or physically bonded. At this time, the nanowire crystalline material having a multi-layered structure is formed of semiconductive or conductive crystallized compounds which are stacked on each other several times, and all of the overlapping layers may be formed of the same material or at least two materials different from each other. For example, when a transition metal and a material, such as Pt or Pd, which highly reacts with hydrogen form a compound, their electrical properties exhibit conductivity or semiconductivivity. When a material having such an electrical property is disposed to have a layered-structure, it may act as a gas adsorption medium.

When the nanowire crystalline material is formed of a thin film having a flat plate structure, an interval between the layers is preferably 1 nm to 100 nm, and the diameter is preferably 1 nm to 1 μm when it has a round (circular) shape. This means a distance allowing the material to be adsorbed to be effectively adsorbed and collected due to chemical and physical attractions. And, a width of the nanowire crystalline material between the layers may range, although not limited thereto, from several nanometers to several micrometers to several tens of centimeters or greater. In addition, the height of the nanowire crystalline material is not limited thereto. This allows several single crystals to be bonded, and the size of the bonded structure is not limited thereto. When a material is adsorbed between the layers of the nanowire crystalline material structure, the distance between the layers is changed to strengthen the adsorbing force.

Therefore, a disadvantage of allowing the adsorbed material to be desorbed outward is complemented. For example, a distance between the nanowire crystalline materials of vanadium pentoxide is changed when a material including a gas is adsorbed from outward.

Meanwhile, a method of fabricating the gas adsorption medium 110 of the present invention will be described as follows.

The gas adsorption medium 110 may be formed of any one selected from a metal oxide, a semiconductor oxide, a compound bonded with transition metal and transition metal oxides, or may be formed of the one which is additionally mixed with an ion change resin and a solvent.

At this time, the ion exchange resin acts to help the growth of the metal oxide or the semiconductor oxide. In addition, the solvent is safely disposed within the nanowire crystalline material to help the nanowire crystalline material including the crystalline metal oxide material, the crystalline semiconductor oxide material or the crystalline solvent-metal(or semiconductor) oxide material to be formed.

The gas adsorption medium 110 may also be fabricated by a sol-gel method, a thin film deposition method including sputtering, or a chemical/physical deposition method. To detail this, the nanowire crystalline material already formed by the sol-gel method may be fabricated in a structure having the shape of a film or bulk, or the thin film may be directly grown to be fabricated. That is, the thin film may be stacked on each other one by one to directly form an empty space between the layers, or a sacrificial layer may be formed between the layers and then removed after the sample is formed, thereby forming the empty space between the layers. For example, in the latter case, at the time of fabricating the gas adsorption medium, the sacrificial layer such as a silicon oxide or a silicon nitride is formed between the layers, and then is removed using an etching process after the gas adsorption medium is fabricated.

In addition, the gas adsorption medium 110 may be fabricated in the form of a bulk using nanoparticles, molecules, or polymers in order to enhance the mutual aggregation ability, i.e, an ability of aggregating the nanowire crystalline material and the nanowire crystalline material.

Meanwhile, the nanowire crystalline material having a multi-layered structure may have a nano thin film structure, a pellet structure, or a film structure. Among these structures, the nano thin film structure is formed by any one method of spin-coating method, an adsorption method using a spuit or a pipette, a method of forming a pellet by applying pressure or a spray method of forming multi layers. To detail this, the solvent is completely evaporated or removed when a nanowire crystalline material and a nanowire compound are contained in the solvent, the nanowire crystalline material and the nanowire compound are then put in a structure and a pressure is applied to the structure to fabricate a pellet-shaped structure, the solvent is filtered by a filtering device including a filtering paper to remove the solvent when the nanowire crystalline material and the nanowire compound are contained in the solvent so that a film-shaped structure may be fabricated, a method using spin-coating may be employed, an adsorption method using a spuit or a pipette may be employed, or a spraying method may be employed to fabricate a nano thin film.

The method using the spin-coating enables a nanowire crystalline material to be adsorbed or attached to a porous material such as sponge or a net structure material. At this time, a thin film having a composite stacked structure may be fabricated by properly increasing the number of repetitions of the spin-coating In particular, after the nanowire crystalline material is adsorbed on the porous material, another porous material is stacked thereon, and then the nanowire crystalline material is spin-coated again.

The spraying method sprays the nanowire crystalline material onto a porous material or a net-structure material to fabricate a thin film. At this time, the nanowire crystalline material is sprayed onto the porous material and adsorbed, and then another porous material is stacked thereon and the nanowire crystalline material is sprayed as done in the spin-coating method.

Meanwhile, the gas adsorption medium 110 may include a material (e.g, water) capable of being adsorbed or desorbed within the nanowire crystalline material for enabling neighboring layers to sustain each other in order to form a stable nanowire crystalline material having a multi-layered structure. At this time, the material capable of being adsorbed or desorbed is bonded with the crystalline nano material by a chemical bond or a physical bond. As such, when other amorphous materials and materials capable of being adsorbed or desorbed are bonded between the layers, the nanowire crystalline material having a multi-layered structure may dissolve the bond by an annealing process to enable the material capable of being adsorbed or desorbed to be desorbed from the nanowire crystalline material, and a material to be adsorbed, including hydrogen, may be adsorbed in an empty space between the layers generated due to the desorption of the material capable of being adsorbed or desorbed.

In addition, the nanowire crystalline material may be subjected to surface processing in order to make a material to be adsorbed including hydrogen more adsorbed within the nanowire crystalline material having the multi-layered structure. At this time, molecules having a silane group, an amine group or a carboxylic group may be employed for the surface processing For example, the molecules having the silane group may employ aminopropyltriethoxysilane (APTES), aminopropy-ltrimethoxysilane (APTMS), and so forth, and these molecules are subjected to surface processing for the nanowire crystalline material to increase the attraction between the nanowire crystalline material and the nanowire crystalline material, which thus helps the nanowire crystalline material to be easily collected to stably maintain the sample.

In addition, besides the method of surface-processing the nanowire crystalline material, a material having a large surface area may be mixed in a solvent to be added at the time of processing the nanowire crystalline material for increasing the adsorption ability. In this case, the large surface area of the material ranges from several nanometers to several thousand micrometers, for example, 1 square nm to 1000 square μm, and examples of the material include polymers such as polypyrrol, polyacetylene, polyethylene, carbon nanotubes, conductive and nonconductive nanowires, and nanodots of organic materials such as pentacenes, naphthalene. When these materials are mixed in a solvent at the time of synthesiing the nanowire crystalline material, the surface area and the aggregation ability of the synthesized nanowire crystalline material may be increased to increase the adsorption capacity of adsorbing a material to be adsorbed. For example, when polypyrrol is employed, polypyrrol allows a nano-sized material to be fabricated using an electrochemical method, so that when a nanowire is injected and synthesized with polypyrrol, the nanowire-polypyrrol compound is crystallized to strengthen the aggregation ability between the nanowire crystalline materials, which in turn may make it difficult to desorb the material due to the surface tension of polypyrrol once the material to be adsorbed is adsorbed.

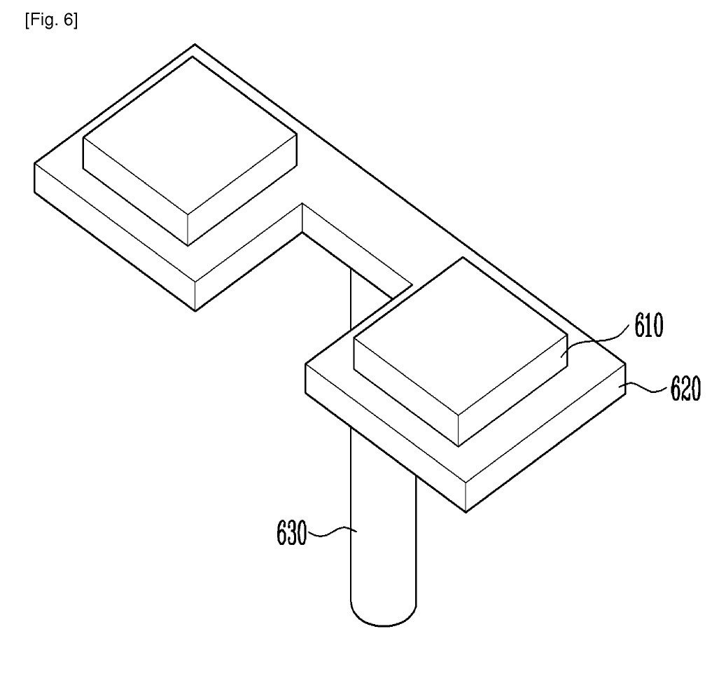

The present invention also provides a gas adsorption pump having the gas adsorption medium as described above. An example of the adsorption pump using the gas adsorption medium according to the present invention is illustrated in FIG. 6.

The adsorption pump shown in FIG. 6 includes a cooler 630, a cooling panel 620 disposed on the cooler 630, and a nanowire adsorption medium 610 disposed on the cooling panel 620.

According to the adsorption pump shown in FIG. 6, cooling generating from the cooler 630 is delivered to the cooling panel 620, and then cools the nanowire adsorption medium 610 to adsorb gas molecules distributed around.

### Embodiment

### Fabrication of Gas Adsorption Medium

### Fabrication of Crystalline Vanadium Nanowire Material

Ammonium meta-vanadate of 0.4 g and an ion exchange resin of 4 g were put into distilled water of 80 mg for 72 hours or more to synthesize a nanowire. When the ratio mentioned above was properly adjusted, a sol-shaped material was transformed into a gel-shaped material over time to form such a nanowire. After the nanowire compound and the nanowire contained in the distilled water were filtered by a filtering device to remove the distilled water, a film-shaped structure was fabricated.

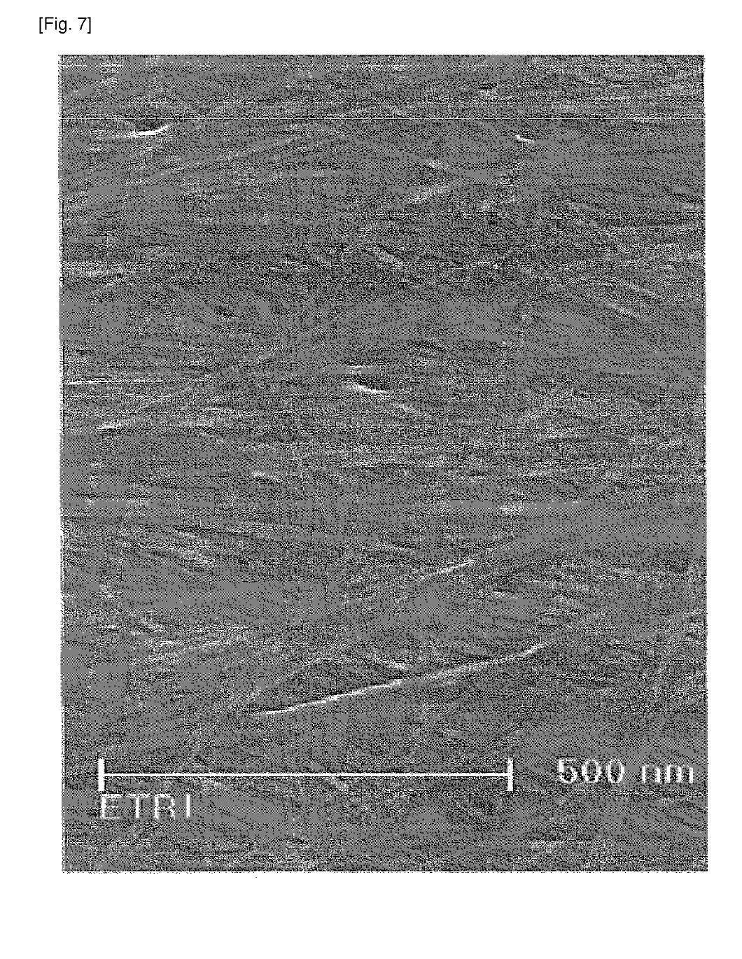

FIG. 7 illustrates a scanning electron microscope (SEM) photo of a synthesized crystalline vanadium pentoxide. Referring to the scanning electron microscope (SEM) photo shown in FIG. 7, it illustrates the nanowire which was dropped onto the silicon oxide substrate, dried, and then inserted into a scanning electron microscope chamber. As can be seen from the result, the net structure of the nanowire is formed by the crystalline nano material.

### <Experiment>

### Measurement of Amount of Adsorbed Crystalline Vanadium Nanowire Material

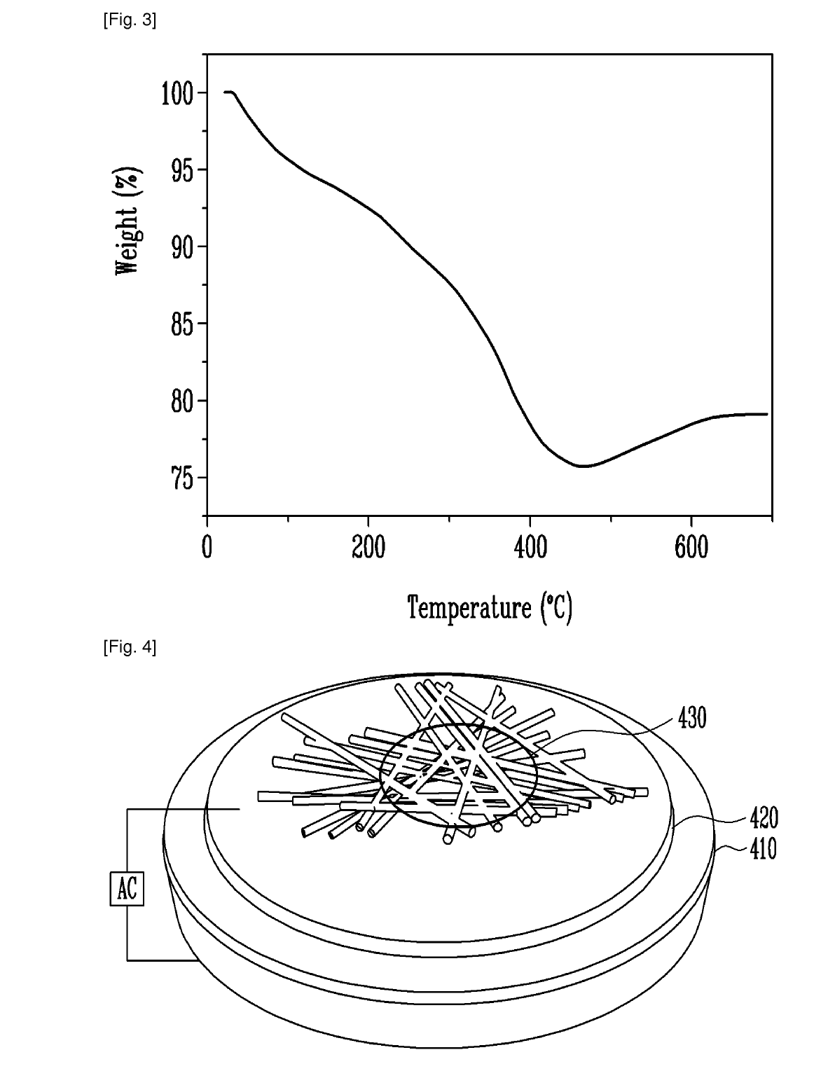

According to the present experiment, in order to analyze the amount of adsorbed gas of a gas adsorption apparatus including the vanadium pentoxide fabricated in the embodiment described above as a gas adsorption medium, the experiment was done using thermogravimetric analysis (TGA), and its results were shown in FIG. 3. At this time, the experiment method measured a change in weight (weight ratio) according to temperature to provide information about analysis of sample composition and thermal stability, and compared a mass of the gas adsorption medium filled with a material capable of being adsorbed or desorbed before the gas is adsorbed with a mass of the gas adsorption medium when all of the material capable of being adsorbed or desorbed was removed to check the maximum weight percent of the gas which can be adsorbed in a state that the gas is not adsorbed in the present experiment, thereby measuring the maximum amount of adsorbed gas.

As shown in FIG. 3, it can be seen that the mass of the crystalline vanadium nanowire material was decreased from an initial 100 weight % to 75 weight % at around 500° C. when crystalline vanadium nanowire materials were inserted into the TGA device and temperature was increased from 0° C. up to 700° C. while the solvent containing the crystalline vanadium nanowire material was completely removed. This means that the mass when only the crystalline vanadium nanowire material is present without water adsorbed in the crystalline vanadium nanowire material is 75 weight % of the mass of the initial gas adsorption medium, and this result indicates that the gas may be adsorbed up to 25 weight % of the mass of the gas adsorption medium. In addition, this indicates the change in mass when the water already filled was completely removed. This indicates the amount of water contained in the sample when the sample was fabricated, which in other words enables the vanadium nanowire to best collect the water molecules even in the air. That is, a general adsorption pump may adsorb the water floating in the air. This may be most effectively applied to removal of water which is most required for making a vacuum state using an adsorption pump and other pumps.

Meanwhile, the adsorption pump for adsorbing the gas also acts to remove hydrogen which was difficult to remove due to the fine molecular weight of hydrogen in a vacuum state. To this end, the property of the hydrogen adsorption was performed using the vanadium nanowire.

Several methods of measuring an amount of hydrogen adsorbed in a gas adsorption medium are well known. In this case, a mass spectrometry, that is, a quartz crystal microbalance (QCM) device was employed to measure the amount of adsorbed hydrogen. The configuration of the QCM device is shown in FIG. 4.

Referring to FIG. 4, the QCM device includes two electrodes 420 (one electrode is disposed behind a quartz oscillator 410), and the quartz oscillator 410 interposed between the electrodes 420. Its operation principle is as follows. An alternating current (AC) voltage is applied to both electrodes 420 to oscillate the quartz oscillator 410 through which a resonance occurs to determine an oscillation frequency. In this case, the resonance frequency of the quartz oscillator 410 is 9 MHz and when an object having mass is put on the quartz oscillator 410 at the resonance frequency, the natural resonance frequency is changed. At this time, the change in the resonance frequency is closely associated with the change in mass. That is, Dm=−1.068 Df(ng). 1.068 Df indicates a constant associated with the quartz property, and its unit is nanogram.

A gas adsorption medium for analying an adsorbed amount is put on the QCM device, and an oscillation is applied using an oscillator to measure its response property. Such a QCM device is put in a chamber which may heat and cool the device and maintain the vacuum state, and its property is measured externally. At this time, the decrease in frequency means an increase in mass, and the increase in frequency means a decrease in mass.

### Analysis of Amount of Adsorbed Hydrogen

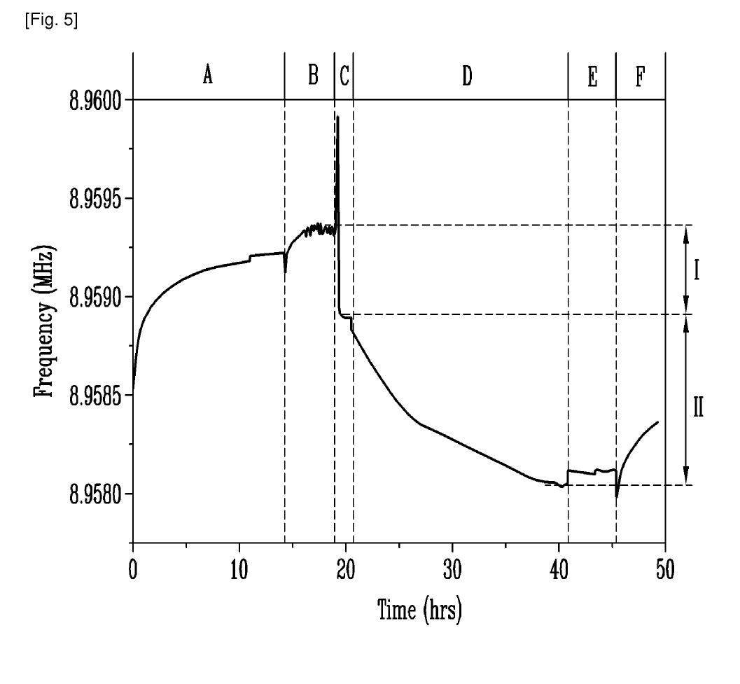

FIG. 5 illustrates a graph analying the amount of adsorbed hydrogen, wherein an X-axis denotes time and a Y-axis denotes frequency.

Referring to FIG. 5, region A is a region indicating the frequency measured while the sample put on the QCM device of FIG. 4 is kept at a pressure of 1×10⁻³ Torr and a temperature of 20° C., region B is a region where the temperature was increased to 100° C. at the same vacuum state with respect to the sample, region C is a region where the pressure was increased to 11.3 atm at the same temperature, 100° C., region D is a region where the temperature was decreased to 20° C., at the same pressure, 11.3 atm, region E is a region where the pressure was increased to 20 Torr at 20° C., and region F is a region where the pressure was decreased to 1.6×10⁻³ Torr at the same temperature, 20° C. Such measurements facilitate analysis of the gas adsorption ability. That is, the change in mass when the temperature was decreased from 100° C. to 20° C. at the same pressure, that is, the amount of gas adsorbed from an interval I may be analyzed. The amount of hydrogen adsorption according to the temperature through such measurements is 2.6 wt %. That is, it can be seen that the rate occupied by the total adsorption mass is 2.6 wt % with respect to the sum of the adsorbed mass and the mass of nanowire. This represents that the adsorption amount is susceptible to the change in temperature. This allows the adsorption of the adsorption pump at the very low temperature to be facilitated. In addition, it can be seen from the results of FIG. 5 that the change in pressure at the same temperature allows the adsorption to be further facilitated at the interval II.

The technical spirit of the present invention has been described in preferred embodiments, however, these embodiments are illustrative not limitative. In particular, the present invention has been described with respect to a crystalline vanadium pentoxide nanowire material, however, a gas adsorption medium of the present invention is not limited to the crystalline vanadium pentoxide nanowire material only. As described above, an adsorption medium formed by bonding between transition metal, other metal and elements, a bulk-shaped adsorption medium formed of their crystalline material, and compounds having a chemical bond with Pt or Pd are all included so long as their crystals allow a space to have a multi-layered structure, that is, allow the space to be secured between the layers. In addition, a structure including a material which may be easily exhausted at the time of sample synthesis is possible, and a structure to be removed after synthesis is also possible. In addition, it will be understood by those skilled in the art that various changes in form and details may be made therein without departing from the spirit and scope of the invention as defined by the appended claims.

1. A gas adsorption medium comprising:
a multi-layered structure of which the layers are spaced apart from each other,
wherein the layers are formed of an ion valence-variable material with extra electrons not participating in a chemical bond.

2. The gas adsorption medium according to claim 1, wherein a molecular material capable of being adsorbed or desorbed between the layers is chemically or physically bonded with the ion valence-variable material in the multi-layered structure.

3. The gas adsorption medium according to claim 1, wherein the layers are formed of the same material as or different materials from each other.

4. The gas adsorption medium according to claim 1, wherein the layers are spaced apart from each other by 0.1 nm to 100 nm in the multi-layered structure.

5. The gas adsorption medium according to claim 1, wherein the ion valence-variable material has an asymmetric structure where at least two structures are bonded to each other.

6. The gas adsorption medium according to claim 1, wherein the ion valence-variable material is a nanowire crystalline material.

7. The gas adsorption medium according to claim 6, wherein the nanowire crystalline material is formed of one selected from the group consisting of a semiconductor nanowire material, a compound bonded with a transition metal and a transition metal oxide.

8. The gas adsorption medium according to claim 7, wherein the semiconductor nano material includes one selected from the group consisting of Si, Ge, Sn, Se, Te, B, C(including diamond), P, B—C, B—P(BP6), B—Si, Si—C, Si—Ge, Si—Sn, Ge—Sn, SiC, BN/BP/BAs, AlN/AlP/AlAs/AlSb, GaN/GaP/GaAs/GaSb, InN/InP/InAs/InSb, BN/BP/BAs, AlN/AlP/AlAs/AlSb, GaN/GaP/GaAs/GaSb, InN/InP/InAs/InSb, ZnO/ZnS/ZnSe/ZnTe, CdS/CdSe/CdTe, HgS/HgSe/HgTe, BeS/BeSe/BeTe/MgS/MgSe, GeS, GeSe, GeTe, SnS, SnSe, SnTe, PbO, PbS, PbSe, PbTe, CuF, CuCl, CuBr, CuI, AgF, AgCl, AgBr, AgI, BeSiN₂, CaCN₂, ZnGeP₂, CdSnAs2, ZnSnSb₂, CuGeP₃, CuSi₂P₃, (Cu, Ag)(Al, Ga, In, Ti, Fe)(S, Se, Te)₂, Si₃N₄, Ge₃N₄, Al₂O₃, (Al, Ga, In)₂(S, Se, Te)₃, Al₂CO, and a combination containing at least two thereof.

9. The gas adsorption medium according to claim 7, wherein the transition metal includes one selected from Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, and Hg

10. The gas adsorption medium according to claim 7, wherein the compound bonded with a transition metal includes one selected from LaNi₅, MnNi₃, Mg₂Ni, TiMn₂, TiV₂, TiFe, TiCo, TiVCr, TiVMn, Mg₂Cu, ZrMn₂, ZrV₂ and LiAl.

11. The gas adsorption medium according to claim 7, wherein the transition metal oxide is vanadium oxide.

12. The gas adsorption medium according to claim 11, wherein the vanadium oxide is one selected from VO₂, V₂O₃, and V₂O₅.

13. The gas adsorption medium according to claim 7, wherein the nanowire crystalline material has a shape of a nano thin film, a pellet, a bulk, or a film.

14. The gas adsorption medium according to claim 7, wherein the nanowire crystalline material is doped with an ion through ion implantation.

15. The gas adsorption medium according to claim 14, wherein the ion is one selected from transition metals.

16. The gas adsorption medium according to claim 7, wherein the nanowire crystalline material is formed by adding an ion exchange resin and a solvent.

17. The gas adsorption medium according to claim 16, wherein a material having a surface area of 1 square nanometer to 1000 square micrometers is mixed in the solvent.

18. The gas adsorption medium according to claim 16, wherein a carbon nanotube, a conductive nanowire, a nonconductive nanowire and a nanodot-shaped material of one selected from an organic materials is mixed in the solvent.

19. The gas adsorption medium according to claim 16, wherein at least one polymer selected from the group consisting of polypyrrol, polyacetylene and polyethylene is mixed in the solvent.

20. The gas adsorption medium according to claim 7, wherein the nanowire crystalline material is subjected to surface processing using molecules of one selected from the group consisting of molecules having a silane group, molecules having an amine group and molecules having a carboxylic group.

21. The gas adsorption medium according to claim 20, wherein the molecules having the silane group are aminopropyltriethoxysilane (APTES) or aminopropy-ltrimethoxysilane (APTMS).

22. An adsorption pump comprising the gas adsorption medium according to claim 1.
